(19) United States
(12) Patent Application Publication
(10) Pub. No.: US 2007/0106971 A1
(43) Pub. Date: May 10, 2007

(54) Apparatus for a routing system

(75) Inventors: Jung-Cheun Lien, San Jose, CA (US); Minchen Zhao, Palo Alto, CA (US)

Correspondence Address: BIRCH STEWART KOLASCH & BIRCH, PO BOX 747, FALLS CHURCH, VA, 22040-0747, US

(73) Assignee: LIZOTECH, INC.

(21) Appl. No.: 11/590,765

(22) Filed: Nov. 1, 2006

Related U.S. Application Data
(60) Provisional application No. 60/733,731, filed on Nov. 4, 2005.

(51) Int. Cl. G06F 17/50

(52) U.S. Cl. 716/13

(57) ABSTRACT

The invention details methods and apparatus for a routing system or router that includes a model. The model can be in many different forms including but not limited to: resolution enhancement technologies such as OPC; lithography model including but not limited to aerial image; pattern-dependent functions; functions for timing/signal integrity/power; manufacturing process variations; and measured silicon data. In one embodiment, the model can be described as input to the system and the model calculator can interact either with the data structure or the query engine of the detail router or both. The model calculator can accept input as a set of geometry description and produce output to guide the query functions. An example technique called set intersection is disclosed herein to combine multiple models in the system. A preferred embodiment of this invention includes a full chip grid-based router being aware of manufacturability.

### CLAIM OF BENEFIT TO PROVISIONAL APPLICATION

This patent application claims the benefit of the earlier-filed U.S. Provisional Patent Application entitled “Methods and Apparatus for a Routing System”, having Ser. No. 60/733,731, and filed Nov. 3, 2005.

### BACKGROUND OF THE INVENTION

1. Field of the Invention

The present invention relates to an apparatus for a routing system, particularly to a routing system or a router that includes a model.

2. Description of the Related Art

Existing routers are software systems that accept two parts of information namely the user design data and the rules-constraints-costs data. A router of such art tries to route all nets in the user design according to the rules-constraints-costs description. The router produces a complete layout suitably for subsequent processing steps such as physical verification and tape-out to manufacturing.

Routing is generally divided into two steps: global routing and detail routing. For each net, global routing generates a pre-determined route for the interconnect lines that are to connect the pins of the net. After global routes have been created, the detail routing creates specific individual routing paths for each net.

Some methods are disclosed to reduce the size of the IC's and increase the efficiency of the layouts. U.S. Pat. No. 7,107,564, titled “Method and Apparatus for Routing a Set of Nets”, specifies a topological routing solution for a group of nets. The method initially identifies a set of initial routing solutions for each net in the group of nets. Each of a plurality of initial routing set of routing solutions has a plurality of topological routes. Each topological route is a route that represents a set of geometric routes that are morphable into one another. Next, the method specifies a best topological routing solution from the initially identified sets of topological routing solutions for the nets. The best routing solution has one route for each net in the group of nets. Although this method utilizes specifying a best topological routing solution from the topological routing solutions to optimize the integrated circuit layouts, it still needs a physical verification process to guarantee the manufacturability. When some violations occur, the IC designer has to modify the routes and executes the physical verification process. The steps are repeated until all violations are eliminated.

U.S. Pat. No. 7,086,447, titled “Method and Apparatus for Efficiently Locating and Automatically Correcting Certain Violations in a Complex Existing Circuit Layout”, modifies an existing large scale chip layout to reinforce the redundant via design rules to improve the yield and reliability. The method operates on each metal-via pair from bottom up to locate and correct isolated via rule violations by adding metal features and vias in a respective patch cell associated with each cluster cell. A large complex design is thus divided into cells. This method deals with the existing circuit layout. The steps of routing, checking, and correcting processes are repeated until all violations are eliminated.

When the integrated circuit is developed at sub-wavelength geometries, the route for the integrated circuit is complex. Therefore, a large amount of violations will occur by using the existing routers. The steps of routing, checking, and correcting processes are repeated. It is time-consuming.

### SUMMARY OF THE INVENTION

One particular aspect of the present invention is to detail methods and apparatus for a routing system or router that includes a model. The model can be in many different forms including but not limited to: resolution enhancement technologies such as optical proximity correction (OPC), lithography model including but not limited to aerial image, pattern-dependent functions, functions for timing/signal integrity/power, manufacturing process variations, and measured silicon data.

A further particular aspect of the present invention is to reduce the violations when the integrated circuit is routed. For a complex integrated circuit, the steps of routing, checking, and correcting processes are substantially reduced.

In one embodiment, the model can be described as input to the system and the model calculator can interact either with the data structure or the query engine of the detail router or both. The model calculator can accept input as a set of geometry description and produce output to guide the query functions. An example technique called set intersection is disclosed herein to combine multiple models in the system. A preferred embodiment of this invention includes a full chip grid-based router being aware of manufacturability.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the routing system of the present invention;

FIG. 2 is a detailed block diagram of the routing system of the present invention;

FIG. 3 is a schematic diagram of how model is incorporated into detail router; and

FIG. 4 is a perspective diagram of the method to combine multiple models using set intersection.

### DETAILED DESCRIPTION OF THE PREFERRED EMBODIMENTS

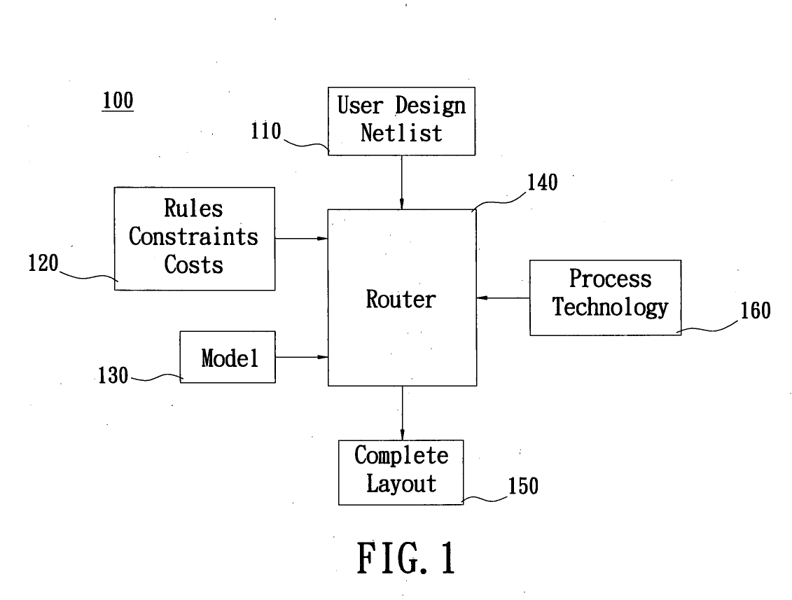

FIG. 1 shows a simplified block diagram of a router system 100. Module 110 represents a user design netlist. All instances in the netlist have been placed previous by a placer. Some or all nets in the netlist can be pre-routed. The netlist can be in any common formats include but not limited to LEF, DEF. The netlist can also be stored in a different database such as OpenAccess. Module 160 represents process technology used to manufacture the design. Module 120 represents inputs to the router including rules, constraints and costs. Module 130 represents at least one model that can represent one of many purposes including but not limited to a) timing and delay of cell, or interconnect, b) signal integrity, c) power consumption and/or IR drop, d) key process parameters from measured silicon data, e) resolution enhancement technology (RET) & lithography, and f) a routing pattern-dependent. Here RET includes but not limited to optical proximity correction (OPC) and phase shifted mask (PSM). The lithography includes but not limited to the following process parameters such as aerial image, resist, process window, defocus and exposure dose, critical dimension variations (CDV), develop and etch. The router 140 will follow rules and constraints and try to minimize cost, all while trying to route all nets in the design. Module 140 represents the router system (a routing engine) that takes inputs as 110, 120, 130, 160 and produces output 150, which is a complete layout.

Note that multiple models can be deployed to the router 140 even though only a single model 130 is shown in FIG. 1. In particular, for example, more than one lithography or RET models can be employed in the router 140.

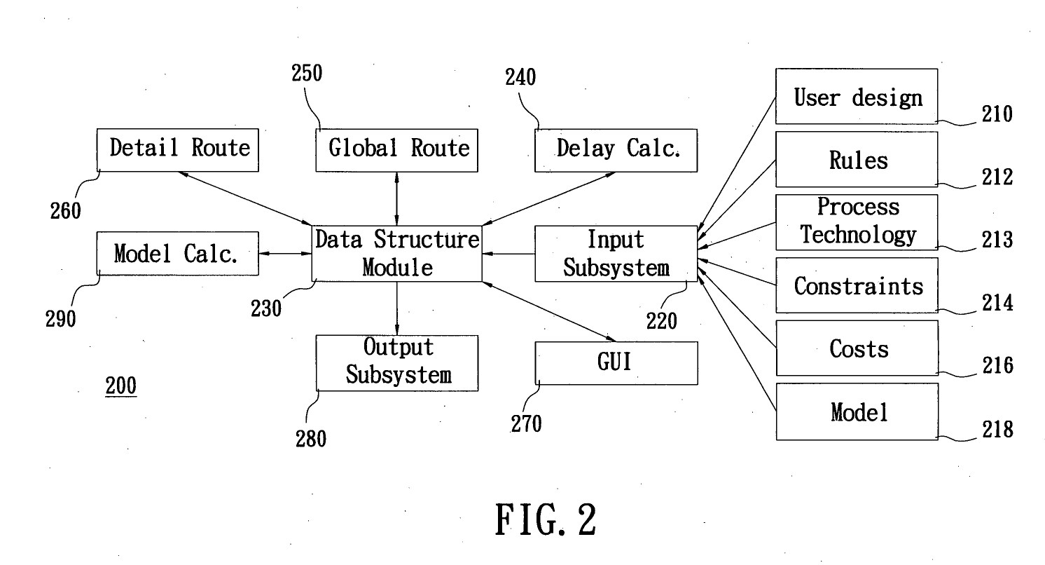

FIG. 2 illustrates a model-based router 200 according to the current invention. The router 200 includes an input subsystem 220, a data structure module 230, a delay calculator 240, a global route 250, a detail route 260, a GUI 270, an output subsystem 280 and a model calculator 290. The data structure 230 stores all information required by the router 200. The input subsystem 220 reads information into the data structures from various sources including: user design 210, rules 212, process technology 213, constraints 214, costs 216, and models 218. The delay calculator 240 calculates the required delay according to the information stored in the data structure module 230. The delay calculator 240 needs to be fast since it will be executed many times. Usually, it is an estimate rather than a full delay calculation. The global route 250 routes all nets without full details and the detail route 260 finish the routing in full details for all nets. The model calculator 290 performs some calculation for the deployed models and passes the results to the detail router 260 and to the data structure module 230. The output subsystem 280 provides the results of routing. When some or all nets have been previously routed, this router 200 optimizes layout based in part on models 218. A preferred embodiment of this invention is a full chip grid-based router. In this embodiment, an internal grid or graph representation is included.

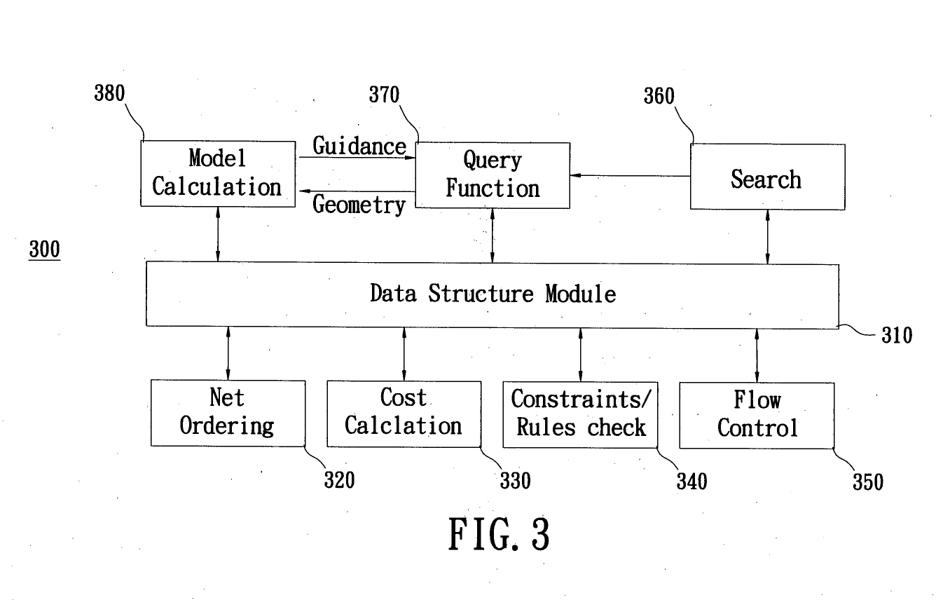

FIG. 3 elaborates how models are used in a detail router 300. At the core of the detail router 300 is data structure module 310 that allows all processing steps of the detail router 300 to share information. Box 320 orders nets to be processed by the router 300 in an optimal way. Box 330 calculates costs for routing current net. Box 340 performs check on rules and constraints for the routing. Box 350 is a flow control that put the entire router 300 together. Box 360 is the main search engine for the detail router 300. The search engine needs to do frequent queries. Box 370 represents various query functions that support the search. Some query function get guidance from the model calculator 380 by providing specific geometry information. The model calculator 380 accepts inputs as geometry represent in grids and/or shapes that has been stored in the data structures 310 and produces output to guide the query functions 370 and/or search functions 360 in the detail router 300.

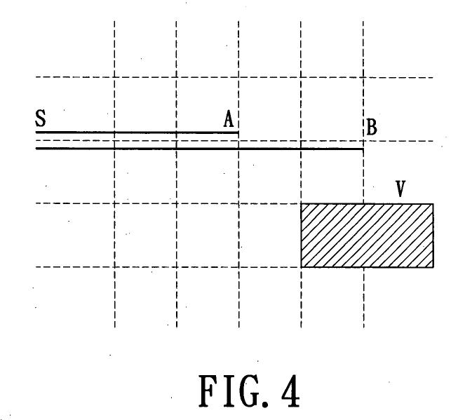

FIG. 4 shows the use of set operation technique to combine multiple models to guide detail router 300. In this example, there is some kind of violation V produced by the box with hatched pattern. Model 1 indicates that the route segment starting from S can only go as long as point A. Model 2 indicates that the route segment can go all the way to point B. The set intersection technique implies that the common intersection segments SA and SB is the results of combining both model 1 and 2. Therefore in this example, the router 300 will use segment SA. Furthermore, the model calculator 380 uses superstition operations, set operations, algebra operations, geometry algebra operations, linear algebra operations, correction operations, and/or convolution operations to combines the outputs from the multiple models.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A router system to produce layout for Integrated Circuits, comprising:
a routing engine;
an user design netlist module;
a ruling module including rules, constraints and costs;
a process technology module; and
at least one model description;
wherein the routing engine uses the user design netlist module, the ruling module, the process technology module, and the model description to finish a complete layout.

2. The router system to produce layout for Integrated Circuits as claimed in claim 1, wherein the model is built according to parameters that is relative to required manufacturing process when the produced layout is manufactured into Integrated Circuits.

3. The router system to produce layout for Integrated Circuits as claimed in claim 1, wherein the model comprises at least one of the following:
a resolution enhancement technology including optical proximity correction or phase shifted mask;
a lithography model including aerial image, resist, develop, or etching;
a routing pattern-dependent function;
a function to describe timing and/or delay of cell or interconnect;
a function to describe signal integrity;
a function to describe power consumption or IR drop;
a function of manufacturing process including process window, defocus and exposure dose, or critical dimension variations; and
a function or data derived from measured data on silicon fabricated by the intended process.

4. The router system to produce layout for Integrated Circuits as claimed in claim 1, wherein the router optimizes layout based in part on the models when some or all nets have been previously routed.

5. The router system to produce layout for Integrated Circuits as claimed in claim 3, wherein the router optimizes layout based in part on the models when some or all nets have been previously routed.

6. The router system to produce layout for Integrated Circuits as claimed in claim 1, further comprising an internal grid or graph representation.

7. A router system to produce layout for Integrated Circuits, comprising:
a data structure module storing information required by the router system;
an input subsystem reading information into the data structure module from user design, rules, constraints, costs, and at least one model;
a delay calculator calculating required delay according to the information stored in the data structure module;
a global router routing all nets without full details;
a detail router finishing the routing in full details for all nets;
a model calculator performing calculation for the models and passing the result to the detail router and the data structure module; and
an output subsystem outputting the results of routing.

8. The router system to produce layout for Integrated Circuits as claimed in claim 7, further comprising a graphical user interface.

9. The router system to produce layout for Integrated Circuits as claimed in claim 7, wherein the model is built according to parameters that is relative to required manufacturing process when the in the produced layout is manufactured into Integrated Circuits.

10. The router system to produce layout for Integrated Circuits as claimed in claim 7, wherein the model comprises at least one of the following:
a resolution enhancement technology including optical proximity correction or phase shifted mask;
a lithography model including aerial image, resist, develop, or etching;
a routing pattern-dependent function;
a function to describe timing and/or delay of cell or interconnect;
a function to describe signal integrity;
a function to describe power consumption or IR drop;
a function of manufacturing process including process window, defocus and exposure dose, critical dimension variations; and
a function or data derived from measured data on silicon fabricated by the intended process.

11. The router system to produce layout for Integrated Circuits as claimed in claim 7, wherein the router optimizes layout based in part on the models when some or all nets have been previously routed.

12. The router system to produce layout for Integrated Circuits as claimed in claim 7, wherein the model calculator accepts inputs as geometry represented in grids and/or shapes and produces output to guide the query and/or search functions in detail router.

13. The router system to produce layout for Integrated Circuits as claimed in claim 7, wherein the model calculator combines multiple models using techniques from at least one of the following:
superposition operations;
set operations;
algebra operations;
geometry algebra operations;
linear algebra operations;
correlation operations; and
convolution operations.

14. The router system to produce layout for Integrated Circuits as claimed in claim 7, further comprising an internal grid or graph representation.

15. The router system to produce layout for Integrated Circuits as claimed in claim 10, wherein the router optimizes layout based in part on the models when some or all nets have been previously routed.

16. The router system to produce layout for Integrated Circuits as claimed in claim 10, wherein the model calculator accepts inputs as geometry represented in grids and/or shapes and produces output to guide the query and/or search functions in detail router.

17. The router system to produce layout for Integrated Circuits as claimed in claim 10, wherein the model calculator combines multiple models using techniques from at least one of the following:
superposition operations;
set operations;
algebra operations;
geometry algebra operations;
linear algebra operations;
correlation operations; and
convolution operations.

18. The router system to produce layout for Integrated Circuits as claimed in claim 12, wherein the model calculator utilizes at least some stored pre-computed information.

19. The router system to produce layout for Integrated Circuits as claimed in claim 16, wherein the model calculator utilizes at least some stored pre-computed information.
